(19) United States
(12) Patent Application Publication
(10) Pub. No.: US 2024/0375359 A1
(43) Pub. Date: Nov. 14, 2024

(54) LASER TRANSMISSIVE RESIN COMPOSITION AND MOLDED ARTICLE THEREOF

(71) Applicant: Polyplastics Co., Ltd., Tokyo (JP)

(72) Inventors: Takato Isomura, Fuji-shi (JP); Koki Nagai, Fuji-shi (JP); Kazuya Goshima, Fuji-shi (JP); Hiroki Fukatsu, Fuji-shi (JP)

(73) Assignee: Polyplastics Co., Ltd., Tokyo (JP)

(21) Appl. No.: 18/287,378

(22) PCT Filed: May 20, 2022
(86) PCT No.: PCT/JP2022/020905

§ 371 Date: Oct. 18, 2023

(30) Foreign Application Priority Data
May 28, 2021 (JP) 2021-089662

(51) Int. Cl. B29C 65/00; B29C 65/16; B29K 67/00; B29K 105/00

(52) U.S. Cl. CPC B29C 66/71; B29C 65/1635; B29K 2067/006; B29K 2105/0032; B29K 2995/0021; B29K 2995/0027

(57) ABSTRACT

A laser transmissive resin composition is disclosed with high laser transmissiveness, good color development, and in which color transfer does not occur and a molded article using the same. The laser transmissive resin composition (I) includes, with respect to 100 parts by mass of a polyester-based resin (A), 0.005-5.0 parts by mass of an organic pigment (B) including at least a benzimidazolone-based yellow pigment (b1), wherein a 1 mm thick molded article of the resin composition (I) has a CIE L* value of 25 or less and a 940 nm laser transmittance of 40% or greater.

### TECHNICAL FIELD

The present application relates to a laser transmissive resin composition and a molded article thereof.

### BACKGROUND ART

Welding is a processing method applied to thermoplastic resins and is a method wherein heat is applied to a portion of a resin product which is intended to be joined to melt the same and the site is then adhered and joined by cooling and solidification. Among such methods, laser welding involves superimposing a laser transmissive resin and a resin comprising a laser absorbent and joining the resins to one another by irradiating with a laser. Diode lasers and YAG lasers with wavelengths around 800-1200 nm, which are slightly longer than those of visible light, are typically used in laser welding. If laser transmissiveness and absorbency can be ensured in this wavelength region, joining is possible and it is also possible to join colored resin products by selecting dyes or laser absorbents.

Laser transmissiveness varies by resin and transparent resins with high laser transmissiveness such as polycarbonate-based resins, polymethyl(meth)acrylate-based resins (PMMA resins), polystyrene-based resins (PS resins), semitransparent resins such as polyacetal-based resins (POM resins) and polyamide-based resins (PA resins), and resins with high concealing properties and low laser transmissiveness such as polyester-based resins are used.

Because laser transmissiveness is high in resins in which transparency is relatively high and because sufficient color development is possible even with a small amount of a coloring agent, high laser transmissiveness can be maintained. Meanwhile, laser welding is difficult with polyester-based resins with low laser transmissiveness and methods are employed wherein amorphous resins are combined (for example, Patent Document 1) and wherein coloring agents or the like with high transmissiveness are added (for example, Patent Document 2).

In relation to laser transmissive coloring agents, Patent Document 3, for example, indicates that a laser transmissive resin can be colored black by using a mixture of a perylene-based red, an isoindolinone-based yellow, and a phthalocyanine-based blue.

Conventionally, importance is placed on transmissiveness for coloring agents used in laser welding and dyes or pigments with comparatively small particle diameters are used. Such coloring agents are suitable for laser welding because they have superior transmissiveness, but in addition to dyes themselves having low thermal resistance and coloring agents sublimating or decoloring when used at high temperatures, there are problems such as the occurrence of color transfer when contacted with other materials and the contamination of other materials.

With regard to the abovementioned problems, Patent Document 4 indicates that a laser light transmissive resin composition comprising an anthraquinone-based and/or naphthalimide-based polymer dye does not readily transfer color to another article during laser welding. Moreover, Patent Document 5 indicates that a thermoplastic colored resin composition for laser welding which is free of manganese (Mn) and comprises a metal oxide does not readily discolor even in high-temperature environments. Furthermore, Patent Document 6 indicates that a polyester resin composition for laser welding which has a coloring agent comprising a phthalocyanine-based pigment does not readily discolor or undergo thermal degradation. However, the suppression of color transfer during laser welding is not sufficient in any of these resin compositions.
Patent Document 1: JP 2004-315805 A
Patent Document 2: JP 2004-168997 A
Patent Document 3: JP 2006-199861 A
Patent Document 4: JP 2007-297473 A
Patent Document 5: JP 2007-023263 A
Patent Document 6: JP 2008-133341 A

### SUMMARY OF INVENTION

The objective of the present invention is to provide a laser transmissive resin composition with high laser transmissiveness, good color development, and in which color transfer does not occur and a molded article using the same.

As a result of diligent research, the present inventors found that a laser transmissive resin composition which is capable of solving all of the abovementioned problems is obtained by blending a certain amount of an organic pigment comprising at least a benzimidazolone-based yellow pigment with a polyester-based resin, arriving at the present invention.

That is, the present invention has the following aspects.
[1] A laser transmissive resin composition (I) comprising, with respect to 100 parts by mass of a polyester-based resin (A), 0.005-5.0 parts by mass of an organic pigment (B) comprising at least a benzimidazolone-based yellow pigment (b1), wherein a 1 mm thick molded article of the resin composition (I) has a CIE L* value of 25 or less and a 940 nm laser transmittance of 40% or greater.
[2] The laser transmissive resin composition (I) described in [1], wherein the organic pigment (B) comprises the benzimidazolone-based yellow pigment (b1) and at least one pigment selected from a phthalocyanine-based blue pigment (b2) and a perylene-based red pigment (b3).
[3] The laser transmissive resin composition (I) described in [2], wherein the yellow pigment (b1) comprises at least one pigment selected from Pigment Yellow 180 and Pigment Yellow 181, the blue pigment (b2) comprises at least one pigment selected from Pigment Blue 15:3 and Pigment Blue 16, and the red pigment (b3) comprises Pigment Red 149.
[4] The laser transmissive resin composition (I) described in any one of [1] to [3], wherein the polyester-based resin (A) comprises a polybutylene terephthalate-based resin.
[5] The laser transmissive resin composition (I) described in any one of [1] to [4], further comprising an inorganic filler (C).
[6] The laser transmissive resin composition (I) described in any one of [1] to [5], further comprising an amorphous resin (D).
[7] A molded article formed using the laser transmissive resin composition (I) described in any one of [1] to [6].

According to the present invention, a laser transmissive resin composition with high laser transmissiveness, good color development, and in which color transfer does not occur and a molded article using the same can be provided.

### DESCRIPTION OF EMBODIMENTS

An embodiment of the present invention shall be explained in detail below. The present invention is not limited by the following embodiment and can be carried out with the addition of appropriate modifications so long as the effects of the present invention are not hindered. In the present specification, “-” means “ . . . or greater and . . . or less”. For example, “0.005-5.0 parts by mass” means “0.005 parts by mass or greater and 5.0 parts by mass or less”.

### Laser Transmissive Resin Composition (I)

A laser transmissive resin composition (I) according to the present embodiment is characterized by comprising, with respect to 100 parts by mass of a polyester-based resin (A), 0.005-5.0 parts by mass of an organic pigment (B) comprising at least a benzimidazolone-based yellow pigment (b1), wherein a 1 mm thick molded article of the resin composition (I) has a CIE L* value of 25 or less and a 940 nm laser transmittance of 40% or greater. The laser transmissive resin composition (I) of the present embodiment (hereafter described simply as “resin composition (I)”) has high laser transmissiveness and good color development and color transfer does not occur therein.

The CIE L* value of a 1 mm thick molded article of the resin composition (I) according to the present embodiment is 25 or less, preferably 23 or less, and more preferably 20 or less. Because the CIE L* value is 25 or less, a 1 mm thick molded article of the resin composition (I) according to the present embodiment exhibits dark colors. Note that “CIE” is a quantitative display method for colors defined by the Commission Internationale de l'Éclairage (International Commission on Illumination). Further, “L* value” is a measure representing lightness. The CIE L* value of a molded article of the resin composition (I) according to the present embodiment specifically indicates a value measured with the following method.

### Method of Measuring the CIE L* Value

The resin composition (I) is injection molded under conditions of a cylinder temperature of 260° C. and a mold temperature of 80° C. to make an 80 mm×80 mm×1 mm thick test piece (molded article). The value when measuring the obtained test piece using a color computer (for example, product name: Spectrophotometer SE 6000 manufactured by NIPPON DENSHOKU INDUSTRIES CO., LTD) under conditions of a ø 10 mm aperture, illuminant C/two-degree field of view, and reflection is used as the CIE L* value.

In the resin composition (I) according to the present embodiment, the laser transmittance at a wavelength of 940 nm is 40% or greater. The laser transmittance is preferably 42% or greater and more preferably 44% or greater. If the laser transmittance is 40% or greater, molded articles obtained from the resin composition (I) according to the present embodiment can easily be joined with other members by laser welding. The laser transmittance of a molded article of the resin composition (I) according to the present embodiment specifically indicates a value measured with the following method.

### Method of Measuring Laser Transmittance

The resin composition (I) is injection molded under conditions of a cylinder temperature of 260° C. and a mold temperature of 80°° C. to make an 80 mm×80 mm×1 mm thick test piece (molded article). The 940 nm laser transmittance is measured by using a spectrophotometer (for example, product name: V-770 UV-visible/NIR Spectrophotometer and Integrating Sphere ISN-923 manufactured by JASCO Corporation) on the obtained test piece.

### Polyester-Based Resin (A)

The resin composition (I) according to the present embodiment comprises a polyester-based resin (A).

From the viewpoint of moldability of the resin composition (I), the ratio of the polyester-based resin (A) in the resin composition (I) is preferably 30-90% by mass with respect to the total mass of the resin composition (I), more preferably 35-80% by mass, and still more preferably 45-70% by mass.

As the polyester-based resin (A), conventionally known polyester resins can be used alone or in a combination of two or more. Preferably, the polyester-based resin is that consisting of a dicarboxylic acid or a derivative thereof and a diol.

Examples of the dicarboxylic acid or derivative thereof include, for instance, aromatic dicarboxylic acids, alicyclic dicarboxylic acids, aliphatic dicarboxylic acids, and ester-forming derivatives thereof. Among these, comprising an aromatic dicarboxylic acid or an ester-forming derivative thereof is preferred. Examples of polyester-based resins (A) comprising an aromatic dicarboxylic acid or an ester-forming derivative thereof include, for instance, polyethylene terephthalate-based resins (PET resins), polybutylene terephthalate-based resins (PBT resins), polytetramethylene terephthalate resins (PTT resins), etc. Among these, from the viewpoint of mechanical properties and laser transmissiveness, comprising a PBT resin, a PET resin, and a PTT resin is preferred and from the viewpoint of moldability, comprising a PBT resin is preferred. In one embodiment, the polyester-based resin (A) may be a PBT resin.

### PBT Resins

PBT resins are obtained by polycondensation of an aromatic dicarboxylic acid component comprising at least terephthalic acid or an ester-forming derivative thereof (a C₁₋₆ alkylester, acid halide, etc.) and a glycol component comprising at least a C₄ alkylene glycol (1,4-butanediol) or an ester-forming derivative thereof (an acetylate, etc.). In the present embodiment, the PBT resin is not limited to homopolybutylene terephthalate resins and may be a copolymer containing 60 mol % or greater butylene terephthalate units.

The amount of carboxyl group terminals in the PBT resin is preferably 50 meq/kg or less, more preferably 30 meq/kg or less, and still more preferably 25 meq/kg or less. The amount of carboxyl group terminals is a value representing the amount of unreacted carboxylic acid groups in a polymer chain. If the amount of carboxyl group terminals is 50 meq/kg or less, the hydrolysis resistance readily becomes favorable. Further, the amount of carboxyl group terminals can be determined by heating the PBT resin at 215° C. for 10 minutes in benzyl alcohol to dissolve the resin and then titrating with a 0.01 N aqueous solution of sodium hydroxide.

The intrinsic viscosity of the PBT resin can be appropriately adjusted within a range where the objective of the present embodiment is not hindered, but from the viewpoint of fluidity the intrinsic viscosity is preferably 0.60 dL/g or greater and 1.20 dL/g or less and more preferably 0.65 dL/g or greater and 0.90 dL/g or less. Further, the intrinsic viscosity may be adjusted by blending PBT resins having different intrinsic viscosities. For example, by blending a PBT resin having an intrinsic viscosity of 0.90 dL/g with a PBT resin having an intrinsic viscosity of 0.70 dL/g, a PBT resin having an intrinsic viscosity of 0.80 dL/g can be prepared. The intrinsic viscosity of the PBT resin can be measured under conditions of, for example, a temperature of 35° C. in o-chlorophenol.

In preparing the PBT resin, when using an aromatic dicarboxylic acid, other than terephthalic acid, or an ester-forming derivative thereof as a comonomer component, for example, a C₈₋₁₄ aromatic dicarboxylic acid such as isophthalic acid, phthalic acid, 2,6-naphthalenedicarboxylic acid, or 4,4′-dicarboxydiphenylether; a C₄₋₁₆ alkanedicarboxylic acid such as succinic acid, adipic acid, azelaic acid, or sebacic acid; a C₅₋₁₀ cycloalkanedicarboxylic acid such as cyclohexanedicarboxylic acid; or an ester-forming derivative of these dicarboxylic acid components (a C₁₋₆ alkylester derivative, acid halide, etc.) can be used. These dicarboxylic acid components may be used alone or in a combination of two or more.

Among the abovementioned dicarboxylic acid components, a C₈₋₁₄ aromatic dicarboxylic acid such as isophthalic acid and a C₄₋₁₆ alkanedicarboxylic acid such as adipic acid, azelaic acid, or sebacic acid are preferred.

In preparing the PBT resin, when using a glycol component other than 1,4-butanediol as a comonomer component, for example, a C₂₋₁₀ alkylene glycol such as ethylene glycol, propylene glycol, trimethylene glycol, 1,3-butylene glycol, hexamethylene glycol, neopentyl glycol, or 1,3-octanediol; a polyoxyalkylene glycol such as diethylene glycol, triethylene glycol, or dipropylene glycol; an alicyclic diol such as cyclohexanedimethanol or hydrogenated bisphenol A; an aromatic diol such as bisphenol A or 4,4′-dihydroxybiphenyl; a C₂₋₄ alkylene oxide adduct of bisphenol A such as an ethylene oxide 2-mol adduct of bisphenol A or a propylene oxide 3-mol adduct of bisphenol A; or an ester-forming derivative of these glycols (an acetylate, etc.) can be used. These glycol components may be used alone or in a combination of two or more.

Among these glycol components, a C₂₋₁₀ alkylene glycol such as ethylene glycol or trimethylene glycol, a polyoxyalkylene glycol such as diethylene glycol, an alicyclic diol such as cyclohexanedimethanol, etc. are more preferred.

The PBT resin may comprise comonomer components other than the dicarboxylic acid component and glycol component discussed previously. Examples of other comonomer components include, for instance, aromatic hydroxycarboxylic acids such as 4-hydroxybenzoic acid, 3-hydroxybenzoic acid, 6-hydroxy-2-naphthoic acid, and 4-carboxy-4′-hydroxybiphenyl; aliphatic hydroxycarboxylic acids such as glycolic acid and hydroxycaproic acid; C₃₋₁₂ lactones such as propiolactones, butyrolactones, valerolactones, and caprolactones (ε-caprolactone, etc.); and ester-forming derivatives of these comonomer components (C₁₋₆ alkylester derivatives, acid halides, acetylates, etc.). These comonomer components may be used alone or in a combination of two or more.

The ratio of the PBT resin included in the polyester-based resin (A) is preferably 50% by mass or greater with respect to the total mass of the polyester-based resin (A) and more preferably 70% by mass or greater. Further, the ratio of PBT resin in the polyester-based resin (A) may be 100% by mass.

Moreover, the ratio of the PBT resin in the resin composition (I) is preferably 30-90% by mass with respect to the total mass of the resin composition (I), more preferably 40-80% by mass, and still more preferably 50-70% by mass.

### PET Resins

PET resins are obtained by a polycondensation reaction of a dicarboxylic acid component comprising at least terephthalic acid or an ester-forming derivative thereof and a glycol component comprising at least a C₂ alkylene glycol (ethylene glycol) or an ester-forming derivative thereof. PET resins may be homo PET resins and may be copolymer (copolymer PET) resins containing 60 mol % or greater (particularly from about 75 mol % to 95 mol %) ethylene terephthalate units.

Examples of the dicarboxylic acid components (comonomer components) in copolymer PET resins other than terephthalic acid and ester-forming derivatives thereof include, for instance, aromatic dicarboylic acid components (C₆₋₁₂ aryl dicarboxylic acids and the like such as isophthalic acid, phthalic acid, naphthalene dicarboxylic acids, and diphenyl ether dicarboxylic acids), aliphatic dicarboxylic acid components (C₅₋₁₀ cycloalkyl dicarboxylic acids and the like such as succinic acid, adipic acid, azelaic acid, and sebacic acid), aromatic hydroxycarboyxlic acids (hydroxybenzoic acid, hydroxynaphthoic acid, and the like), ester-forming derivatives thereof, etc. Preferred dicarboxylic acid components (comonomer components) include aromatic dicarboylic acid components (in particular, C₆₋₁₀ aryl dicarboxylic acids such as isophthalic acid) and aliphatic dicarboxylic acid components (in particular, C₆₋₁₂ alkyl dicarboxylic acids such as adipic acid, azelaic acid, and sebacic acid).

Examples of glycol components (comonomer components) other than ethylene glycol include aliphatic diol components (for example, alkylene glycols (C₃₋₁₀ alkylene glycols such as propylene glycol, trimethylene glycol, 1,3-butylene glycol, hexamethylene glycol, neopentyl glycol, and 1,3-octanediol; polyoxy C₂₋₄ alkylene glycols such as diethylene glycol, triethylene glycol, and dipropylene glycol; etc.), alicyclic diols such as cyclohexanedimethanol and hydrogenated bisphenol A, etc.), aromatic diol components (aromatic alcohols such as bisphenol A and 4,4′-dihydroxybiphenyl; C₂₋₄ alkylene oxide adducts of bisphenol A (for example, an ethylene oxide 2-mol adduct of bisphenol A, a propylene oxide 3-mol adduct of bisphenol A, etc.), and the like), ester-forming derivatives thereof, etc. These glycol components may be used alone or in a combination of two or more.

Preferred glycol components (comonomer components) include aliphatic diol components (in particular, C₃₋₆ alkylene glycols; polyoxy C₂₋₃ alkylene glycols such as diethylene glycol; and alicyclic diols such as cyclohexanedimethanol). Homo PET resins and copolymer PET resins can each be used alone or in mixtures of two or more.

Furthermore, the comonomer units of copolymer PET resins are at least one residue selected from aromatic dicarboxylic acid residues (in particular, at least C₃₋₁₀ alkylene glycol residues and polyoxy C₂₋₃ alkylene glycol residues). Copolymer PET resins include isophthalic acid copolymer PET resins (isophthalic acid-modified PET resins) and the like.

### PTT Resins

PTT resins are obtained by a polycondensation reaction of a dicarboxylic acid component comprising at least terephthalic acid or an ester-forming derivative thereof and a diol component comprising at least C_{3 1,3}-propanediol. PTT resins are not limited to homo PTT resins and may be copolymer (copolymer PTT) resins containing 60 mol % or greater tetramethylene terephthalate units.

When the PTT resin is a copolymer PTT, examples of the monomers to be copolymerized include dicarboxylic acids, dicarboxylic acid esters, and the like. As specific examples, there are dicarboxylic acids such as oxalic acid, malonic acid, succinic acid, glutaric acid, adipic acid, isophthalic acid, 2,6-naphthalenedicarboxylic acid, biphenyl dicarboxylic acid, 5-sodiumsulfoisophthalic acid, 5-potassiumsulfoisophthalic acid, 5-lithiumsulfoisophthalic acid, 2-sodiumsulfoisophthalic acid, 2-potassiumsulfoisophthalic acid, 2-lithiumsulfoisophthalic acid, 4-sodiumsulfo-2,6-naphthalenedicarboxylic acid, 2-sodiumsulfo-4-hydroxybenzoic acid, and tetrabutylphosphonium 5-sulfoisophthalate, oxyacetates and lower alcohol esters thereof such as methanol, and the like. These may be used alone or in a mixture of two or more.

### Organic Pigment (B)

The resin composition (I) according to the present embodiment comprises 0.005-5.0 parts by mass of an organic pigment (B), which comprises at least a benzimidazolone-based yellow pigment (b1), with respect to 100 parts by mass of the polyester-based resin (A). By comprising such an organic pigment (B), the resin composition (I) and a molded article thereof with good color development and in which color transfer does not occur can be obtained. Note that “having good color development” means that coloring can be performed with a small amount of a pigment and that there is no uneven color development.

Moreover, the ratio of the organic pigment (B) in the resin composition (I) is preferably 0.1-0.8 parts by mass with respect to 100 parts by mass of the polyester-based resin (A), more preferably 0.2-0.7 parts by mass, and especially preferably 0.3-0.6 parts by mass.

### Benzimidazolone-Based Yellow Pigment (b1)

The organic pigment (B) comprises at least the benzimidazolone-based yellow pigment (b1) (hereafter described as “yellow pigment (b1)”). The yellow pigment (b1) is an organic yellow pigment comprising a benzimidazolone structure in the skeleton thereof.

Examples of the yellow pigment (b1) include Pigment Yellow 120, Pigment Yellow 151, Pigment Yellow 154, Pigment Yellow 175, Pigment Yellow 180, Pigment Yellow 181, Pigment Yellow 194, etc. indicated with Colour Index (CI) names and numbers jointly maintained by the Society of Dyers and Colourists and the American Association of Textile Chemists and Colorists. These may be used alone or in a combination of two or more. From the viewpoint of the ease of obtaining a resin composition (I) in which color transfer occurs less readily, comprising, among these, at least one yellow pigment selected from Pigment Yellow 180 and Pigment Yellow 181 is preferred.

Pigment Yellow 181, which is one preferred example of the yellow pigment (b1), is a compound represented by 4′-carbamoyl-4-[1-(2,3-dihydro-2-oxo-1H-benzimidazol-5-ylcarbamoyl) acetonylazo] benzanilide.

The ratio of the yellow pigment (b1) in the organic pigment (B) is preferably 20-50% by mass with respect to the total mass of the organic pigment (B), more preferably 25-45% by mass, and still more preferably 30-40% by mass. Further, the ratio of the yellow pigment (b1) in the resin composition (I) is preferably 0.01-0.4 parts by mass with respect to 100 parts by mass of the polyester-based resin (A), more preferably 0.05-0.35 parts by mass, and still more preferably 0.1-0.3 parts by mass.

The organic pigment (B) preferably comprises the yellow pigment (b1) and at least one pigment selected from a phthalocyanine-based blue pigment (b2) and a perylene-based red pigment (b3). Such an organic pigment (B) makes the CIE L* value of a 1 mm thick molded article of the resin composition (I) more readily adjusted to 25 or less. Further, the organic pigment (B) more preferably comprises the yellow pigment (b1), the phthalocyanine-based blue pigment (b2), and the perylene-based red pigment (b3).

### Phthalocyanine-Based Blue Pigment (b2)

The organic pigment (B) may comprise the phthalocyanine-based blue pigment (b2) (hereafter described as “blue pigment (b2)”). The blue pigment (b2) is a pigment having a phthalocyanine skeleton in the structure thereof and specifically, examples include Pigment Blue 15, Pigment Blue 15:1, Pigment Blue 15:2, Pigment Blue 15:3, Pigment Blue 15:4, Pigment Blue 15:6, Pigment Blue 16, Pigment Blue 17:1, Pigment Blue 75, Pigment Blue 79, etc. represented by the CI names and numbers discussed above. These may be used alone or in a combination of two or more. From the viewpoint of the ease of obtaining a resin composition (I) in which color transfer occurs less readily and which has good color development, comprising, among these, at least one blue pigment selected from Pigment Blue 15:3 and Pigment Blue 16 is preferred.

From the viewpoint of color mixing, when the organic pigment (B) comprises the blue pigment (b2), the content thereof is preferably 15-50% by mass with respect to the total mass of the organic pigment (B), more preferably 20-45% by mass, and still more preferably 25-40% by mass. It is possible to approach an achromatic color by comprising the blue pigment (b2) as the color opposite that of the benzimidazolone-based yellow pigment (b1) and the b* value is more readily controlled. Further, the content of the blue pigment (b2) in the resin composition (1) is preferably 0.01-0.4 parts by mass with respect to 100 parts by mass of the polyester-based resin (A), more preferably 0.05-0.35 parts by mass, and still more preferably 0.1-0.3 parts by mass.

### Perylene-Based Red Pigment (b3)

The organic pigment (B) may comprise the perylene-based red pigment (b3) (hereafter described as “red pigment (b3)”). The red pigment (b3) is a pigment having a structure in which two oxygen atoms constituting a six-membered ring of perylenetetracarboxylic dianhydride have been displaced and specifically, examples include Pigment Red 149, Pigment Red 179, etc. represented by the CI names and numbers discussed above. These may be used alone or in a combination of two or more. From the viewpoint of the ease of obtaining a resin composition (I) in which color transfer occurs less readily and which has good color development, comprising, among these, Pigment Red 149 is preferred.

When the organic pigment (B) comprises the red pigment (b3), the content thereof is preferably 20-50% by mass with respect to the total mass of the organic pigment (B), more preferably 25-45% by mass, and still more preferably 30-40% by mass. Further, the content of the red pigment (b3) in the resin composition (1) is preferably 0.01-0.4 parts by mass with respect to 100 parts by mass of the polyester-based resin (A), more preferably 0.05-0.35 parts by mass, and still more preferably 0.1-0.3 parts by mass.

### Other Pigments

The organic pigment (B) can comprise other pigments beyond the yellow pigment (b1), the blue pigment (b2), and the red pigment (b3). From viewpoints such as adjusting the CIE L* value of the resin composition (I) to a more preferred range of the present embodiment, organic pigments appropriately selected from those used as coloring agents for laser-transmissive resin compositions can be used. Note that in terms of readily obtaining a resin composition (I) in which color transfer does not occur and color reproducibility, the organic pigment (B) is preferably free of other pigments.

### Inorganic Filler (C)

The resin composition (I) preferably comprises an inorganic filler (C). By comprising the inorganic filler (C), mechanical strength and thermal resistance become favorable.

Examples of the inorganic filler (C) include, for instance, fibrous inorganic fillers such as glass fibers, silica fibers, silica/alumina fibers, zirconia fibers, boron nitride fibers, silicon nitride fibers, and boron fibers; and tabular inorganic fillers such as mica and glass flakes. These may be used alone or in a combination of two or more. From the viewpoint of mechanical strength or moldability, comprising a fibrous inorganic filler as the inorganic filler (C) is preferred and comprising glass fibers is more preferred. As the glass fibers, those with an average fiber length in the range of 150-800 μm are preferred and those with an average fiber length in the range of 200-600 μm are more preferred. If the glass fiber length is short, the strength-improving effects are low and if the glass fiber length is too long, fluidity is lowered and dispersibility of the glass fibers readily worsens. Further, the glass fiber diameter is preferably 5-20 mm and more preferably 10-18 mm. If the glass fiber diameter is small, scattering of the resin and glass fibers due to laser irradiation increases and the transmittance readily falls and if the glass fiber diameter is too large, clogging readily occurs in nozzles or thin portions of cavities during molding. Moreover, the average fiber length is a value determined by dispersing glass fibers obtained after incinerating a molded article in an electric furnace at 600° C. in a solvent such as water, excluding the glass fibers 50 μm or shorter with an image measurement device or the like, and calculating the weight-average fiber length.

Further, when the resin composition (I) comprises the inorganic filler (C), the content thereof is preferably 40-80 parts by mass with respect to 100 parts by mass of the polyester-based resin (A) and more preferably 50-70 parts by mass. If the content of the inorganic filler (C) is within this range, the balance of fluidity and mechanical properties is more readily favorable.

### Amorphous Resin (D)

The resin composition (I) preferably further comprises an amorphous resin (D). By comprising the amorphous resin (D), the shrinkage factor is reduced and welding faults due to warping of molded articles are readily improved.

The amorphous resin (D) is preferably a thermoplastic amorphous resin and examples include, for instance, polyvinyl chloride-based resins (PVC resins), PS resins, PMMA resins, acrylonitrile-butadiene-styrene resins (ABS resins), acrylonitrile-styrene resins (AS resins), PC resins, modified polyphenylene ether-based resins (m-PPE resins), polyetherimide-based resins (PEI resins), polyamideimide-based resins (PAI resins), etc. From the viewpoint of readily adjusting the 940 nm laser transmittance of a 1 mm thick molded article to 40% or greater or readily improving transmissiveness, comprising, among these, a PC resin, an AS resin, or a PS resin is preferable and comprising a PC resin is more preferable.

When the resin composition (I) comprises the amorphous resin (D), the content thereof is preferably 5-100 parts by mass with respect to 100 parts by mass of the polyester-based resin (A) and more preferably 15-35 parts by mass.

### Other Components

So long as effects of the present embodiment are not hindered, the resin composition (I) may comprise components other than the polyester-based resin (A), the organic pigment (B), the inorganic filler (C), and the amorphous resin (D) discussed previously (other components) in order to impart desired properties in accordance with the purpose thereof. Components conventionally blended with laser transmissive resins can be selected, as appropriate, and used as the other components. For example, stabilizers such as antioxidants and ultraviolet absorbers, hydrolysis resistance improvement agents (for example, epoxy resins or the like), anti-static agents, flame retardants, flame retardant promoters, drip prevention agents, release agents, lubricants, lubricating agents, crystallization promoters, nucleating agents (excluding the inorganic filler (C)), plasticizers, thermoplastic elastomers, etc. can be blended. The other components are preferably blended such that the total amount thereof is less than 30 parts by mass with respect to 100 parts by mass of the polyester-based resin (A), more preferably 25 parts by mass or less, and still more preferably 20 parts by mass or less.

### Manufacturing Method for the Laser Transmissive Resin Composition (I)

So long as the effects of the present embodiment are not hindered, the resin composition (I) according to the present embodiment can be prepared by employing conventionally known methods. For example, (1) a method comprising mixing the polyester-based resin (A), the organic pigment (B), and, as necessary, the inorganic filler (C), the amorphous resin (D), and the other components discussed previously and kneading and extruding with a single-screw or a twin-screw extruder to obtain pellets of the resin composition (I), (2) a method comprising preparing, temporarily, pellets with different compositions (masterbatches) and mixing (diluting) a predetermined amount of the pellets to make the composition that of the resin composition (I), (3) a method comprising directly loading the components in a molding machine to obtain the resin composition (I), and the like can be employed. Note that the pellets may be prepared by, for example, melt-blending components excluding brittle components (the inorganic filler (C), glass-based reinforcement materials, etc.) and then mixing the brittle components.

### Molded Article

The molded article according to the present embodiment is formed by molding the resin composition (I) according to the present embodiment. The molding method is not particularly limited and publicly known molding methods can be employed. For example, after obtaining the resin composition (I) with methods such as (1)-(3) discussed previously, the molded article according to the present embodiment can be made by molding. Further, the molding method for the other molded article comprising a thermoplastic resin also is not particularly limited and publicly known molding methods can be employed.

The molded article may be molded with a commonly employed method such as melt-kneading the resin composition (I) and extrusion molding, injection molding, compression molding, blow molding, vacuum molding, rotary molding, or gas injection molding, but is normally molded by injection molding. Further, the mold temperature during injection molding is normally 40-90° C., preferably 50-80° C., and still more preferably about 60-80° C.

The shape of the molded article is not particularly limited, but the molded article is used by being joined with a mating material (another molded article consisting of a thermoplastic resin) by laser welding, so the molded article is normally a shape (for example, a plate) having at least a contact surface (a plane or the like). Further, the transmissiveness of the molded article according to the present embodiment with respect to laser light is high, so the thickness of the molded article at the site where the laser light is transmitted (thickness in the direction in which the laser light is transmitted) can be selected from a wide range and may be, for example 0.1-3 mm, preferably 0.1-2 mm, and more preferably about 0.5-1.5 mm.

The laser light source is not particularly limited and for example, dye lasers, gas lasers (excimer lasers, argon lasers, krypton lasers, helium-neon lasers, etc.), solid lasers (YAG lasers, etc.), semiconductor lasers, etc. can be used. Normally, a semiconductor laser is used as the laser light.

The molded article according to the present embodiment has excellent laser weldability, so normally it is preferred that the molded article be welded to a mating material resin molded article by laser welding, but as necessary, the molded article can also be welded to the other resin molded article by other thermal welding methods such as, for example, vibration welding methods, ultrasonic welding methods, and hot plate welding methods.

### Composite Molded Article

The molded article according to the present embodiment can be made into a composite molded article. The composite molded article according to the present embodiment is that wherein a molded article constituted by the resin composition (I) (first molded article) and a mate resin molded article (second molded article, another molded article consisting of a thermoplastic resin) are joined and unified by laser welding. For example, two molded articles can be joined and unified to make one molded article (composite molded article) by contacting the first molded article and the second molded article (in particular, at least the portions to be joined are surface contacted) and irradiating with laser light, partially melting the interface between the first molded article and the second molded article to adhere the joint surfaces, and cooling. The composite molded article comprising the molded article according to the present embodiment comprises a first molded article which has high laser transmissiveness and good color development and in which color transfer does not occur, so even if the first molded article and the second molded article are joined by laser welding, the color of the first molded article does not transfer to the second molded article and discoloration also does not readily occur. Further, high joint strength can be maintained in the molded article according to the present embodiment, so composite molded articles in which the first molded article and the second molded article are strongly joined after laser welding can be obtained. Moreover, the strength does not readily decrease after welding as compared with before welding.

In preparing the composite molded article, the laser light irradiation is normally performed in the direction from the first molded article toward the second molded article. The first molded article and the second molded article are welded due to the laser light transmitted through the first molded article heating and melting the interface of the second molded article which comprises an absorbent or coloring agent. Note that a condenser lens or the like may be used, as necessary, to weld by focusing the laser light at the interface between the first molded article and the second molded article.

### Second Molded Article

Polyester-based resins are preferred as the thermoplastic resin constituting the second molded article. High weld strength can be obtained by using polyester-based resins. Examples of polyester-based resins include the same as those listed for the polyester-based resin (A) discussed previously. Further, various thermoplastic resins other than polyester-based resins, such as, for example, olefin-based resins, vinyl-based resins, styrene-based resins, acrylic resins, polyamide-based resins, and polycarbonate-based resins may be included as the thermoplastic resin constituting the second molded article. In particular, the second molded article may be constituted by a polycarbonate-based resin, a styrene-based resin, an acrylic resin, or a resin composition comprising at least one thereof.

The second molded article may comprise an absorbent for laser light or a coloring agent. The coloring agent can be selected according to the wavelength of the laser light and conventionally known inorganic pigments and organic pigments can be employed.

Examples of the inorganic pigment include, for instance, black pigments such as carbon black (for example, acetylene black, lamp black, thermal black, furnace black, channel black, Ketjen black, etc.); red pigments such as iron oxide red; orange pigments such as molybdate orange; and white pigments such as titanium oxide.

Examples of the organic pigment include those which can develop colors such as yellow, orange, red, blue, and green and which have laser transmissiveness. The structures thereof are not particularly limited and include organic pigments such as, for example, azomethine-based, anthraquinone-based, quinacridone-based, dioxazine-based, diketopyrrolopyrrole-based, anthrapyridone-based, isoindolinone-based, indanthrone-based, perynone-based, perylene-based, indigo-based, thioindigo-based, quinophthalone-based, quinoline-based, and triphenylmethane-based dyes. These absorbents or coloring agents may be used alone or in a combination of two or more. Among these, black pigments, particularly carbon black can preferably be used. Carbon black with an average particle diameter of 10-1000 nm can be employed and the average particle diameter may preferably be about 10-100 nm. The ratio of the absorbent or coloring agent is preferably 0.1-10% by mass with respect to the total mass of the resin composition constituting the second molded article, more preferably 0.3-5% by mass, and still more preferably 0.3-3% by mass.

When the thermoplastic resin constituting the second molded article does not comprise an absorbent for laser light or a coloring agent, it is possible to perform laser welding by applying an infrared absorber or the like to the interface of the first molded article and the second molded article.

### Purpose

As discussed previously, the resin composition (I) and the molded article thereof according to the present embodiment have high laser transmissiveness and good color development and color transfer to other members does not occur. Therefore, these can be suitably used as a resin composition and molded article for laser welding. Note that naturally, this does not mean that the use of the resin composition (I) and the molded article thereof according to the present embodiment is limited to laser welding.

A preferred aspect of the present embodiment also includes a composite molded article wherein a molded article consisting of the resin composition (I) according to the present embodiment and a molded article (second molded article) consisting of the abovementioned thermoplastic resin are welded and joined.

Other aspects of the present embodiment are uses or methods of use of the organic pigment (B), preferably the yellow pigment (b1), as a color transfer inhibitor of a resin composition for laser welding. Further, the resin component included in the resin composition for laser welding is preferably the polyester-based resin (A) and more preferably a PBT resin. Further, a PBT resin alone may be included as the resin component.

### EXAMPLES

The present invention shall be explained in detail with the following examples, but the present invention is not limited by the following descriptions.

### Materials

The materials used in the examples and comparative examples are as follows.

### Polyester-Based Resin (A)

(A-1): Isophthalic acid 12.5 mol-modified polybutylene terephthalate resin (manufactured by Polyplastics, Co., Ltd.)

### Organic Pigment (B)

Yellow pigment (b1)
(b1-1): Pigment Yellow 181
Blue pigment (b2)
(b2-1): Pigment Blue 15:3
Red pigment (b3)
(b3-1): Pigment Red 149

### Other Organic Pigments (B′)

(B′-1): Phthalocyanine-based green pigment (Pigment Green 36)
(B′-2): Phthalocyanine-based green pigment (Pigment Green 7)
(B′-3): Monoazo-based yellow pigment (Pigment Yellow 183)
(B′-4): Anthraquinone-based yellow pigment (Pigment Yellow 147)
(B′-5): Isoindolinone-based yellow pigment (Pigment Yellow 110)
(B′-6): Perylene-based purple pigment (Pigment Violet 29)
(B′-7): Perylene-based black pigment (Lumogen black K0087).
   Inorganic filler (C)
(C-1): Glass fibers (manufactured by Nippon Electric Glass Co., Ltd., product name: ECS03 T-127 (average fiber diameter: 13 μm, average fiber length: 3 mm))

### Amorphous Resin (D)

(D-1): Polycarbonate-based resin (manufactured by TEIJIN LIMITED, product name: Panlite® L-1225L)

### Other Components

Thermoplastic elastomer: Polyester-based elastomer (manufactured by TOYOBO CO., LTD., product name: PELPRENE® P-90BD)
Hydrolysis resistance improvement agent: Epoxy resin (manufactured by Mitsubishi Chemical Corporation, product name: 1004K)
Antioxidant: Hindered phenol-based antioxidant (manufactured by BASF Japan Ltd., product name: IRGANOX® 1010)
Lubricant: Diglycerine fatty acid ester (manufactured by RIKEN VITAMIN CO., LTD., product name: RIKEMAL® B74)
Stabilizer: Monocalcium phosphate (manufactured by Taihei Chemical Industrial Co., Ltd.)
Nucleating agent: Boron nitride (manufactured by Mizushima Ferroalloy Co., Ltd.)
Plasticizer: Pyromellitic acid mixed linear alkyl ester (manufactured by ADEKA CORPORATION, product name: ADK CIZER® UL-100)

### Examples 1 and 2

The organic pigment (B) and other components were blended with 100 parts by mass of the polyester-based resin (A) at the ratios shown in Table 1 and then melt-kneaded and extruded using a ø 30 mm twin-screw extruder (manufactured by The Japan Steel Works, LTD., product name: TEX-30) at a cylinder temperature of 260° C., a discharge rate of 15 kg/hr, and a screw speed of 130 rpm to obtain pellets consisting of the resin composition (I). Next, the pellets were injection molded at a cylinder temperature of 260° C. and a mold temperature of 80°° C. to make an 80 mm×80 mm×1 mm thick test piece (molded article). The laser transmissiveness, CIE L* value, a* value, b* value, and color transfer to a second molded article of the obtained test piece were evaluated with the methods shown below. The results are shown in Table 1.

### Method of Measuring the CIE L* Value, the a* Value, and the b* Value

The obtained test piece was measured under conditions of a ø 10 mm aperture, illuminant C/two-degree field of view, and reflection using a color computer (product name: Spectrophotometer SE 6000 manufactured by NIPPON DENSHOKU INDUSTRIES Co., LTD).

### Method of Measuring Laser Transmittance

The 940 nm laser transmittance was measured by using a spectrophotometer (product name: UV-visible/NIR Spectrophotometer V-770 and Integrating Sphere ISN-923 manufactured by JASCO Corporation) on the obtained test piece.

### Evaluation of Color Transfer

Natural-colored pellets of a PBT resin (product name: DURANEX® 3300 EF2001 manufactured by Polyplastics Co., Ltd.) were injection molded at a cylinder temperature of 260° C. and a mold temperature of 80°° C. to obtain a 20 mm×20 mm×1 mm thick second molded article. The obtained second molded article was superimposed with the obtained test piece, heated for 30 hours at 130° C., and then the presence or absence of color transfer to the second molded article was confirmed visually.

### Comparative Examples 1-4

Other than the resin compositions being configured as shown in Table 1, 80 mm×80 mm×1 mm thick test pieces (molded articles) were made with the same method as in Example 1. The laser transmissiveness, L* value, a* value, b* value, and color transfer to the second molded article were evaluated with the same methods as in Example 1. The results are shown in Table 1.

TABLE 1

| | | | | | | COMP. | COMP | COMP. | COMP. |
|---|---|---|---|---|---|---|---|---|---|
| | | | | EX. 1 | EX. 2 | EX. 1 | EX. 2 | EX. 3 | EX. 4 |
| COMPOSITION | POLYESTER- | (A-1) | (PARTS | 100 | 100 | 100 | 100 | 100 | 100 |
| OF RESIN | BASED RESIN | | BY | | | | | | |
| COMPOSITION | (A) | | MASS) | | | | | | |
| (I) | ORGANIC | (b1-1) | | 0.20 | 0.14 | | | | |
| | PIGMENT (B) | (b2-1) | | 0.16 | 0.12 | | 0.12 | | 0.16 |
| | | (b3-1) | | 0.20 | 0.14 | | | | 0.20 |
| | OTHER | (B′-1) | | | | 0.18 | | | |
| | ORGANIC | (B′-2) | | | | | | 0.35 | |
| | PIGMENTS (B′) | (B′-3) | | | | 0.37 | | | |
| | | (B′-4) | | | | | 0.24 | 0.04 | |
| | | (B′-5) | | | | | | | 0.20 |
| | | (B′-6) | | | | | | 0.18 | |
| | | (B′-7) | | | | 0.20 | 0.20 | | |
| | INORGANIC | (C-1) | | 61.1 | 61.1 | 61.1 | 61.1 | 61.1 | 61.1 |
| | FILLER (C) | | | | | | | | |
| | AMORPHOUS | (D-1) | | 25 | 25 | 25 | 25 | 25 | 25 |
| | RESIN (D) | | | | | | | | |
| | OTHER | THERMOPLASTIC | | 10.2 | 10.2 | 10.2 | 10.2 | 10.2 | 10.2 |
| | COMPONENTS | ELASTOMER | | | | | | | |
| | | HYDROLYSIS | | 2.0 | 2.0 | 2.0 | 2.0 | 2.0 | 2.0 |
| | | RESISTANCE | | | | | | | |
| | | IMPROVEMENT | | | | | | | |
| | | AGENT | | | | | | | |
| | | ANTIOXIDANT | | 0.60 | 0.60 | 0.60 | 0.60 | 0.60 | 0.60 |
| | | LUBRICANT | | 0.60 | 0.60 | 0.60 | 0.60 | 0.60 | 0.60 |
| | | STABILIZER | | 0.10 | 0.10 | 0.10 | 0.10 | 0.10 | 0.10 |
| | | NUCLEATING | | 0.02 | 0.02 | 0.02 | 0.02 | 0.02 | 0.02 |
| | | AGENT | | | | | | | |
| | | PLASTICIZER | | 4.10 | 4.10 | 4.10 | 4.10 | 4.10 | 4.10 |
| EVALUATION | CIE | L* VALUE | (—) | 21.23 | 23.20 | 21.51 | 17.08 | 16.98 | |
| RESULTS | | a* VALUE | | −4.25 | −4.68 | −3.73 | −4.83 | −0.29 | |
| | | b* VALUE | | −1.11 | −1.43 | 0.89 | −0.27 | −5.61 | |

| | | | | | | | |
|---|---|---|---|---|---|---|---|
| LASER TRANSMITTANCE (940 nm) | (%) | 41 | 44 | 37 | 39 | 35 | |
| PRESENCE OF COLOR TRANSFER | (—) | NO | NO | YES | YES | YES | YES |

As shown in Table 1, molded articles obtained with the resin compositions of Examples 1 and 2, which satisfy the configuration of the present embodiment, have high laser transmissiveness and good color development and color transfer did not occur when made into a composite molded article. Meanwhile, color transfer to the second molded article occurred when molded articles obtained from the resin compositions of Comparative Examples 1-4, which comprise organic pigments other than the organic pigment (B) of the present embodiment, were made into composite molded articles. Further, the laser transmittance in Comparative Examples 1-3 was also low. According to the results above, it was confirmed that the resin composition (I) and the molded article thereof according to the present embodiment have high laser transmissiveness and good color development and color transfer does not occur.

### INDUSTRIAL APPLICABILITY

Because the resin composition (I) and the molded article thereof according to the present embodiment have high laser transmissiveness and good color development and color transfer does not occur, the resin composition (I) and the molded article thereof have industrial applicability as a resin composition and molded article for laser welding.

1. A laser transmissive resin composition (I) comprising, with respect to 100 parts by mass of a polyester-based resin (A), 0.005-5.0 parts by mass of an organic pigment (B) comprising at least a benzimidazolone-based yellow pigment (b1),
wherein a 1 mm thick molded article of the resin composition (I) has a CIE L* value of 25 or less and a 940 nm laser transmittance of 40% or greater.

2. The laser transmissive resin composition (I) according to claim 1, wherein the organic pigment (B) comprises the benzimidazolone-based yellow pigment (b1) and at least one pigment selected from a phthalocyanine-based blue pigment (b2) and a perylene-based red pigment (b3).

3. The laser transmissive resin composition (I) according to claim 2, wherein the yellow pigment (b1) comprises at least one pigment selected from Pigment Yellow 180 and Pigment Yellow 181,
the blue pigment (b2) comprises at least one pigment selected from Pigment Blue 15:3 and Pigment Blue 16, and
the red pigment (b3) comprises Pigment Red 149.

4. The laser transmissive resin composition (I) according to claim 1, wherein the polyester-based resin (A) comprises a polybutylene terephthalate-based resin.

5. The laser transmissive resin composition (I) according to claim 1, further comprising an inorganic filler (C).

6. The laser transmissive resin composition (I) according to claim 1, further comprising an amorphous resin (D).

7. A molded article formed using the laser transmissive resin composition (I) according to claim 1.

8. The laser transmissive resin composition (I) according to claim 2, wherein the polyester-based resin (A) comprises a polybutylene terephthalate-based resin.

9. The laser transmissive resin composition (I) according to claim 3, wherein the polyester-based resin (A) comprises a polybutylene terephthalate-based resin.

10. The laser transmissive resin composition (I) according to claim 2, further comprising an inorganic filler (C).

11. The laser transmissive resin composition (I) according to claim 3, further comprising an inorganic filler (C).

12. The laser transmissive resin composition (I) according to claim 4, further comprising an inorganic filler (C).

13. The laser transmissive resin composition (I) according to claim 2, further comprising an amorphous resin (D).

14. The laser transmissive resin composition (I) according to claim 3, further comprising an amorphous resin (D).

15. The laser transmissive resin composition (I) according to claim 4, further comprising an amorphous resin (D).

16. The laser transmissive resin composition (I) according to claim 5, further comprising an amorphous resin (D).

17. A molded article formed using the laser transmissive resin composition (I) according to claim 2.

18. A molded article formed using the laser transmissive resin composition (I) according to claim 3.

19. A molded article formed using the laser transmissive resin composition (I) according to claim 4.

20. A molded article formed using the laser transmissive resin composition (I) according to claim 5.
